(19) United States
(12) Patent Application Publication
(10) Pub. No.: US 2013/0081326 A1
(43) Pub. Date: Apr. 4, 2013

(54) Modular Concrete Planter Box System

(71) Applicant: Gary Peterson, Beaverton, OR (US)

(72) Inventor: Gary Peterson, Beaverton, OR (US)

(21) Appl. No.: 13/629,027

(22) Filed: Sep. 27, 2012

Related U.S. Application Data
(60) Provisional application No. 61/626,525, filed on Sep. 29, 2011.

(51) Int. Cl. A01G 9/02

(52) U.S. Cl. CPC A01G 9/02
USPC 47/65.7; 47/66.1; 29/428

(57) ABSTRACT

A Modular Concrete Interlocking Box System and method for constructing the same, comprising at least two rectangular caps having two short sides, two long sides, and a consistent thickness from a first cap overhang to a second cap overhang, including at least two notches located adjacent to each overhang along one long side of the cap, and at least two rectangular panels having two short sides, two long sides, and a consistent thickness from a first panel overhang to a second panel overhang, including at least two notches adjacent to each overhang along both long sides of the panel, such that the notches and the overhangs are constructed and arranged to fittingly interlock the caps with the panels such that a four sided box is formed having the overhangs provide an external leverage grip to easily align the courses and square the internal corners of the four sided box.

### FIELD OF THE INVENTION

The present invention relates to a planter box and more particularly to a modular planter box system having a plurality of identical panels and identical caps.

### BACKGROUND

Planter boxes are well known in the art and are typically used to contain soil or other medium for the growing of plants. Concrete planter boxes are durable but heavy, and most larger versions are poured in place, while the smaller versions come precast. The average home owner must hire out concrete tradesmen in order to install any sizable concrete planter box, as the ground must be prepared, concrete forms need to be constructed, and the concrete professionally worked. Precast planter boxes have been a good alternative but are limited in size, and generally are inadequate in volume for any larger plant or tree.

For many application concrete is the preferred medium of planter box construction because of its ability to maintain optimal soil temperatures by absorbing heat during the hottest part of the day and releasing the heat into the growing medium as the air temperature cools. Concrete is also impervious to water and extremely durable. The downside of concrete is the weight, which limits the size of precast planter boxes, and requires professional assistance when pouring a large custom planter box.

### SUMMARY OF THE INVENTION

The present invention discloses a modular concrete box system, in the preferred embodiment being a planter box, having only two different components, caps and panels, thereby providing for an economy of manufacture. The modular components allow for a single user to build a planter box to a desired height and size without the need for pouring concrete or heavy lifting equipment. Further, the modular components quickly disassemble for moving the concrete box to another location. The planter box is modular in that it is made up of separate modules (panels and caps) that can be arranged, replaced, combined, or interchanged easily. The discrete panels and caps interlock at the corners allowing for vertical placement of the panels and caps, one upon another to form the four sided box until the desired depth of the box is achieved. The caps lay down two sides of the first course of the planter box, then two panels interlocking at the corners finish out the first course. For the next course, four panels are laid down, the first two directly over the caps, and the second two over the panels such that the notches interlock at the corners. Additional courses are added until the desired height is achieved, after which the final course of two caps is laid down, thereby finishing the top perimeter of the box opening. The caps are approximately half the width of the panel, thereby requiring four caps for each planter box, two for the first course and two for the last course, and as many panels as the desired depth dictates.

When not assembled as a box, the caps and panels stack flat one on another providing for storage in confined places.

### BRIEF DESCRIPTION OF THE DRAWINGS

FIG. 1 is a perspective view of the planter box assembled;

FIG. 2 is a perspective side view of the cap;

FIG. 3 is a perspective bottom side view of the cap;

FIG. 4 is a perspective side view of a panel;

FIG. 5 is a perspective view of a panel lying flat on the ground;

FIG. 6 is a perspective view of the planter box having one course assembled;

FIG. 7 is a perspective view of the panel and cap interlocked at the corner;

FIG. 8 is a close up view of the panel and cap interlocked at the corner;

FIG. 9 is a perspective of the planter box having two courses assembled;

FIG. 10 is a perspective view of the corner of the assembled planter box having three courses;

FIG. 11 is the planter box caps and panels configured as a stepped terrace planter using the same inventive components assembled as shown.

### DETAILED DESCRIPTION OF THE DRAWINGS

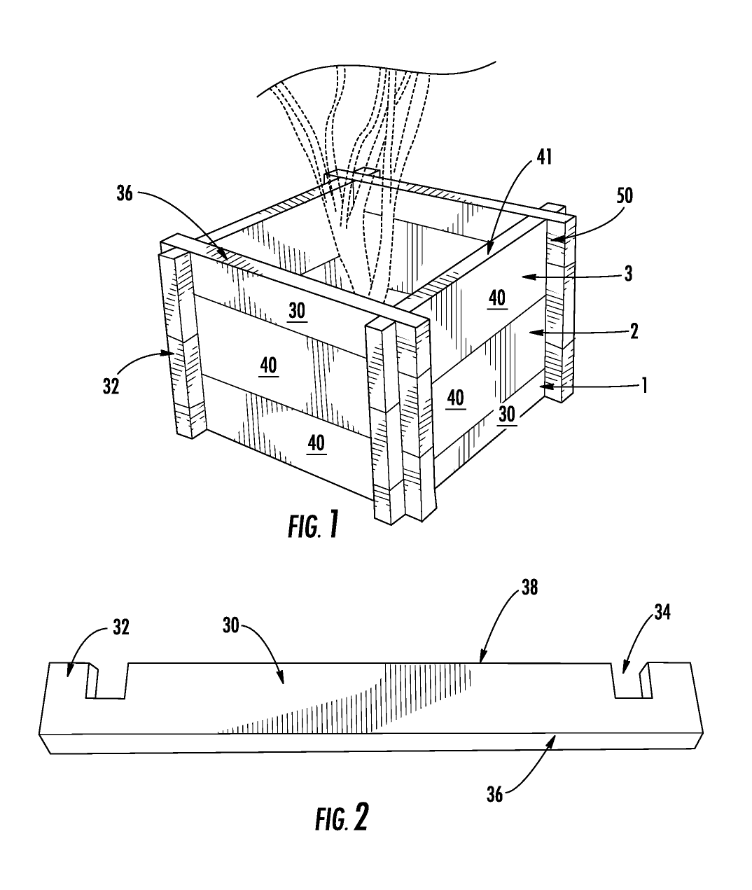

FIG. 1 shows the planter box fully assembled in a three course configuration forming a first wall 100 having a cap 30 shown setting the first course 1, panel 40 stacked over the cap 30 for the second course 2, and so on with the final course 3 finished off with a panel 40. The cap top side 36 of the second wall 200 and panel top side 41 of the first wall 100 making for the top of the planter box edge. At the planter box corners the panels 40 and caps 30 interlock 50 together, such that when installed, form a stable contiguous planter box having overhangs 32 jutting out each corner providing a leverage handle to easily square the internal corners, providing ninety degree angles at each internal corner for the first course and each subsequent course The overhangs 32 further allow for external alignment of the courses to one another as they are laid. Overhangs 32 from both panels 40 and caps 30 provide additional strength and stability in the concrete medium. In the preferred embodiment, the length of the overhang 32 is approximately the same as the thickness of the panel 40 or caps 30 as better shown in the following FIGs. The overhang 32 provides an external handle to leverage the panels 40 and caps 30 into alignment.

The only two discrete components of this inventive system are the caps 30 and panels 40 that allow for assembling and disassembling without the need of tools or fasteners. Each cap 30 and panel 40 are of pre-cast constructed concrete allowing for reproducible production components that are easily transported by a person as they generally weigh less than 50 lbs each, while allowing for the build of a large planter box weighing over a 1000 lbs without the use of any heavy equipment.

FIG. 1 further shows the preferred embodiment having a staggering of seams at the corners for increased strength and rigidity. The panels 40 have substantially uniform cross section, and the caps 30 have substantially half the uniform cross section of the panels 40 thereby allowing for a staggering of the seams (11-14) at each corner. As shown a cap/panel seam 12 as between the cap 30 and panel 40 and a panel/panel seam 11 as between the panels 40 of the second wall 200, do not align with the cap/panel seam 14 and panel/panel seam 13 of the first wall 100.

FIGS. 2 and 3 illustrate the cap 30 having two long sides, a continuous top side 36 and a bottom side 38 with the bottom side 38 having two notches 34 with overhang 32. The notch 34 and overhang 32 provide the mechanism for the cap 30 to interlock with the panel shown in later figures. The notch 34 has a notch width 62 slightly greater than the cap 30 thickness 61. The overhang 32 has an overhang width 60 of approximately the same dimension as the notch width 62, however in the preferred embodiment the overhang width 60 is slightly larger than the notch width 62 to increase strength.

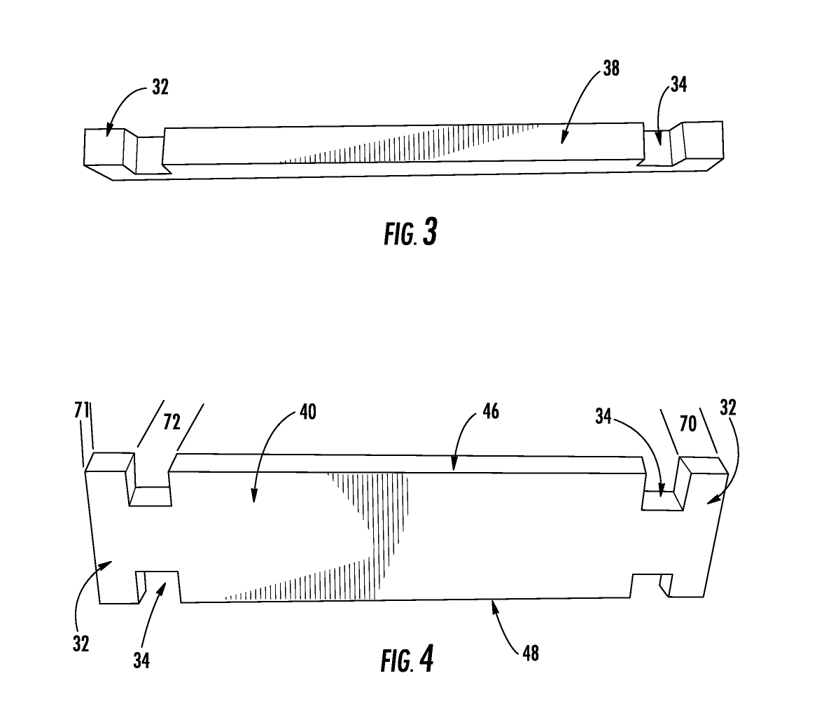

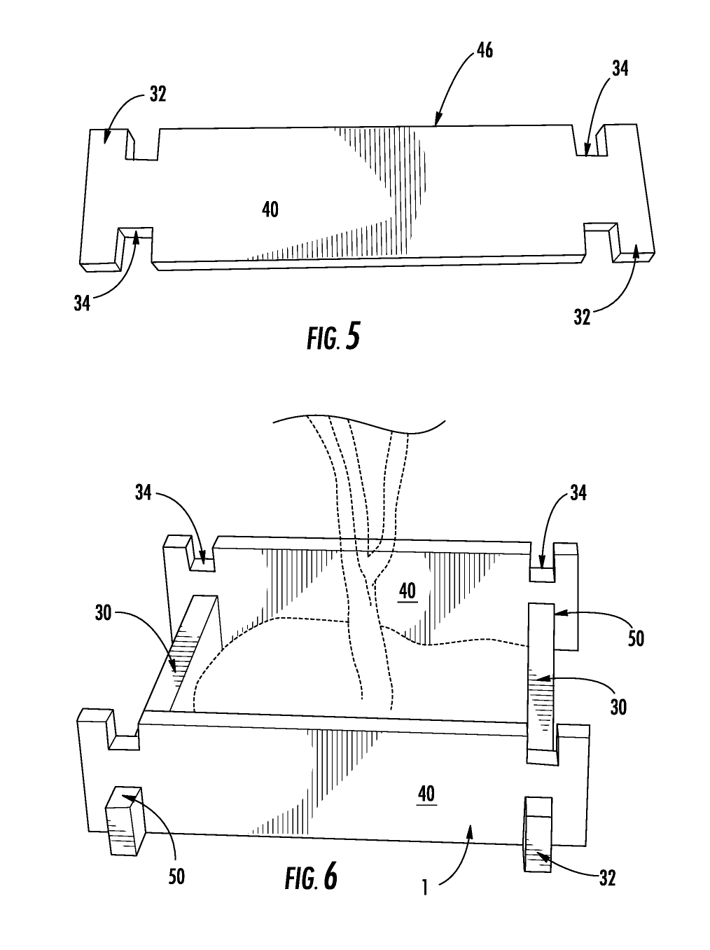

FIGS. 4 and 5 illustrate the panel 40 having a notch 34 and over hang 32 on both top and bottom edges, allowing for the panel to be installed in several ways, as it is by design symmetrical. The panel 40 having two long sides, a continuous upper side 46 and a lower side 48 each having two notches 34 with overhang 32. The notch 34 and overhang 32 provide the mechanism for the panel 40 to interlock with the panels 40 and caps 30 shown in later figures. The notch 34 has a notch width 72 slightly greater than the panel 40 thickness 71. The overhang 42 has an overhang width 70 of approximately the same dimension as the notch width 72, however in the preferred embodiment the overhang width 70 is slightly larger than the notch width 72 to increase strength. In the preferred embodiment the panel 40 shown in FIGS. 4 and 5 and the cap 30 shown in FIGS. 2 and 3 have the same notch width 62 and 72, same overhang width 60 and 70, and same thickness 61 and 71.

FIG. 6 shows the first course 1 laid out, the cap 30 and panel 40 interlock 50 at the corners, with overhang 32 projecting out the side. The second course is ready for install as the notches 34 are ready to receive the next set of panels 40.

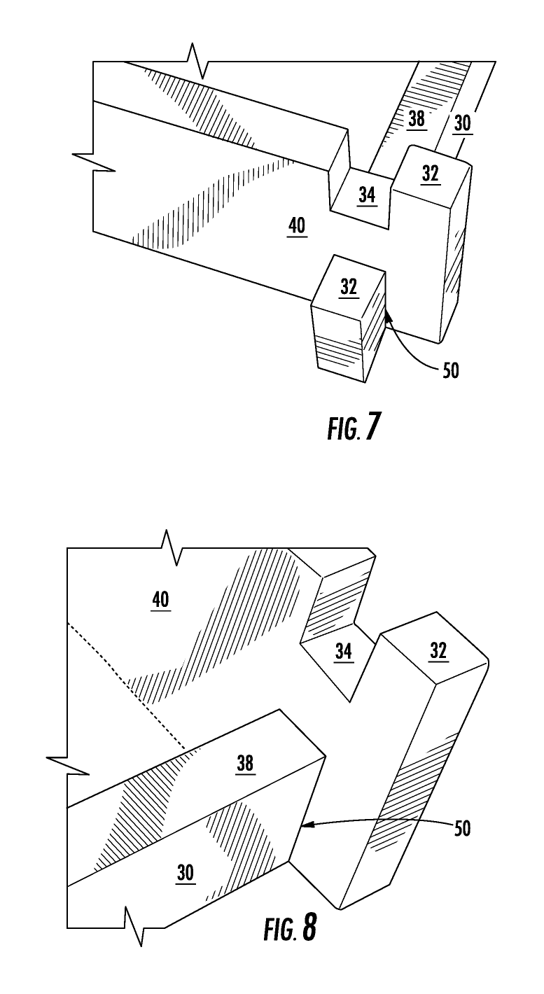

FIG. 7 shows the interconnection of the interlock 50 of the cap 30 and panel 40 as shown in FIG. 6. The overhang 32 projects out, the notch 34 of the panel 40 slides within the notch 34 of the cap 30 on the cap's 30 bottom side 38.

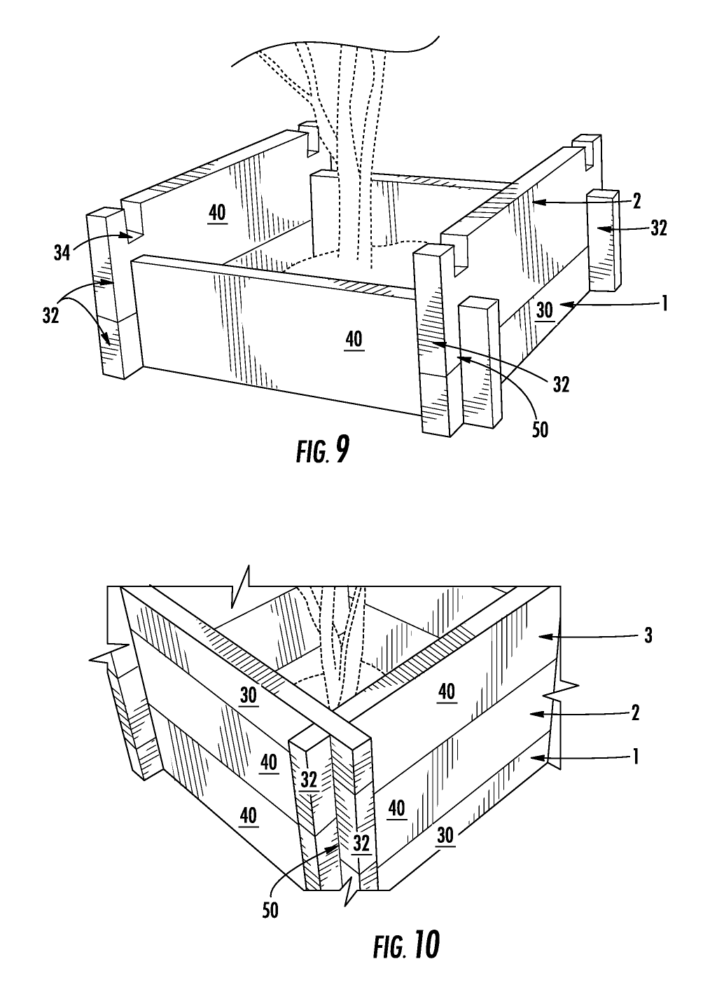

FIG. 8 shows a closer view of the interconnection of the interlock 50 of the cap 30 and panel 40. The overhang 32 projects out, the notch 34 of the panel 40 slides within the notch 34 of the cap 30 on the cap's 30 bottom side 38.

FIG. 9 shows the second course laid out 2 as located above the first course 1, the cap 30 and panel 40 interlock 50 at the corners, with overhang 32 projecting out the side. The third course is ready for install as the notches 34 are ready to receive the next set of panels 40.

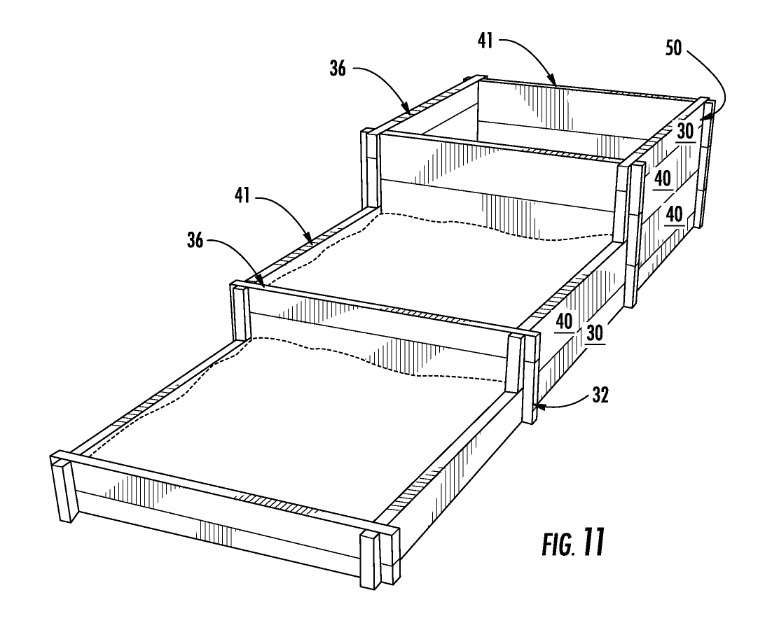

FIG. 10 shows the corner of the completed third course 3, as located above course 2 and course 1. The interlock 50 is accomplished in the same way as the previous two courses, with overhang 32 protruding at the outside corner of the planter box. The planter box shown in FIG. 10 is only a three course embodiment, and one skilled in the art would immediately realize that additional courses make for taller planter boxes and deeper interiors

FIG. 11 shows another embodiment of assembly wherein a terraced planter is formed by building three planter boxes that each share one common wall, each being contiguous and at different elevations. The caps 30 and panels 40 assemble in the same fashion as in the preferred embodiment, however configured as to form a terrace planter alternating the courses along each shared wall. The interlock 50 is accomplished in the same way as the preferred embodiment, with overhang 32 protruding at the outside corner of each planter box. The overhang 32 for each panel 40 or cap 30 may be modified ornamentally per user preference so long as the thickness of each panel 40 or cap 30 remains consistent from overhang 32 to overhang.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims. As shown in FIG. 11, the modular components can be mixed and matched to form many other concrete structures

What is claimed is:

1. A modular concrete interlocking box system, comprising:
i) at least two rectangular caps having two short sides, two long sides, and a consistent thickness from a first cap overhang to a second cap overhang, including at least two notches located adjacent to each overhang along one long side of the cap;
ii) at least two rectangular panels having two short sides, two long sides, and a consistent thickness from a first panel overhang to a second panel overhang, including at least four notches adjacent to each overhang along each long sides of the panel; and
iii) said notches and overhangs are constructed and arranged to fittingly interlock the caps with the panels at each corner such that a four sided box is formed having the overhangs aligned vertically at each external corner.

2. A method of constructing a modular concrete interlocking box system, comprising the steps of:
i) constructing at least two rectangular concrete caps having two short sides, two long sides, and a consistent thickness from a first cap overhang to a second cap overhang, including at least two notches located adjacent to each overhang along one long side of the cap;
ii) constructing a plurality of panels having two short sides, two long sides, and a consistent thickness from a first panel overhang to a second panel overhang, including at least four notches adjacent to each overhang along each long sides of the panel;
iii) laying a first course of two parallel caps notch side up and two parallel panels perpendicular to the caps such that the cap notches and panel notches align and when lowered, slidably interlock the cap notches with the panel notches;
iv) aligning the overhangs such that the internal corners of the first course are at right angles making for a square or rectangle shaped box;
v) laying a next course of four panels two directly over the caps and two directly over the first course panels such that the panel notches of the next course align and slidably interlock with the notches of the below course; and
vi) reiteratively repeating steps iv) and v) until desired box height is achieved.

3. A modular concrete interlocking box system as in claim 1 or 2, further comprising a last course of two caps placed notch side down such that the below panel notches align with the last course caps, and when lowered, slidably interlock the last cap notches with the below panel notches.

4. A modular concrete interlocking box system as in claim 1 or 2, further comprising the overhangs having the same width as the adjacent notch.

5. A modular concrete interlocking box system as in claim 1 or 2, further comprising caps and panels having a thickness of no less than one and a half inches.

6. A modular concrete interlocking box system as in claim 1 or 2, further comprising notches having a width matching the thickness of the panel or cap.

7. A modular concrete interlocking box system as in claim 1 or 2, further comprising overhangs specially formed to facilitate secure handling and easier alignment.
